(19) United States
(12) Patent Application Publication
(10) Pub. No.: US 2009/0222784 A1
(43) Pub. Date: Sep. 3, 2009

(54) Design method estimating signal delay time with netlist in light of terminal line in macro, and program

(75) Inventor: Akihiro Asahina, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/379,350

(22) Filed: Feb. 19, 2009

(30) Foreign Application Priority Data
Feb. 28, 2008 (JP) 2008-047165

(51) Int. Cl. G06F 17/50

(52) U.S. Cl. 716/10

(57) ABSTRACT

A design method according to an aspect of the present invention includes laying out a plurality of functional blocks of a design circuit based on a first netlist, creating a second netlist by adding a first path information to the first netlist, the first path information corresponding to an inter-block line connecting between the functional blocks, creating a third netlist by adding a second path information to the second netlist, the second path information corresponding to an intra-block line connected to a terminal of each functional block from inside of each functional block, creating a fourth netlist that models a line resistance and a line capacitance of an inter-instance line which combines the first path information and the second path information included in the third netlist, and estimating a delay time from information based on the fourth netlist.

### BACKGROUND

1. Field of the Invention

The present invention relates to a design method that estimates signal delay time by using a netlist which is created in light of terminal lines in a macro and a program. Particularly, the present invention relates to a design method that estimates signal delay time by using a netlist which is created in light of the capacitance and resistance of terminal lines in a macro and a program.

2. Description of Related Art

With the recent increase in scale of semiconductor integrated circuits (LSI: large scale integration), the function of the macro incorporated into the LSI to implement prescribed functions becomes complex. Further, with the recent miniaturization of the structure of the integrated circuit, the width of the internal lines narrows accordingly. Further, along with the increase of the scale and size of the macro itself, the line length from the first stage and the last stage in the macro to the external terminal of the macro tends to be long. Consequently, the capacitance and the resistance of the internal line affect signal delay more largely.

FIG. 13 shows a flow chart of a related design method disclosed in Japanese Unexamined Patent Application Publication No. 11-259555. The flow chart of FIG. 13 is described hereinafter in detail.

The method first performs the circuit design to connect predesigned macros (step 1301). From the circuit designed in the circuit design step, the method creates a netlist a that contains circuit connection information (step 1302). According to the created netlist a, the method then performs the layout in the automatic layout step by using an automatic layout tool or the like (step 1303). Based on this layout, the method creates a netlist A that contains information on the line resistance and line capacitance of the lines connected to the macro and the input terminal capacitance of the macro (step 1304). Using the created netlist A, the method implements delay simulation (step 1305). If the result of the delay simulation shows that delay is within the range of specification, the method ends the design. If, on the other hand, the simulated delay is outside the range of specification, the method returns to the automatic layout step (step 1303) or the circuit design step (step 1301) for redesign.

FIG. 14 is the circuit diagram showing the macro used in the netlist A, the line resistance and line capacitance of the line connected to the macro and the input capacitance of the macro. The resistors and capacitors connected to a macro 1401 are described herein with reference to FIG. 14.

Referring to FIG. 14, an input terminal IN1 of the macro 1401 is connected to INST1 through NET1. The INST1 may be another macro, an input buffer, an LSI pad or the like which is connected to the input terminal IN1, for example. The NET1 is a circuit that models the line resistance and line capacitance of the line between the macro 1401 and the INST1. Further, the modeling of the input terminal capacitance is connected to the input terminal IN1 on the inside of the macro. The input terminal capacitance may be a sum of the gate capacitance of an input buffer and the line capacitance from the input terminal IN1 to the device connected first in the macro, for example. In another macro input terminal, such as an input terminal IN2, the resistance and the capacitance are modeled in the same manner.

An output terminal OUT1 is not connected to any device inside the macro 1401. The output terminal OUT1 is connected to INST3 through NET3. The INST3 may be another macro, an output buffer, an LSI pad or the like which is connected to the output terminal OUT1, for example. The NET3 is a circuit that models the line resistance and line capacitance of the line between the macro 1401 and the INST3.

With the use of the above circuits that model the macro 1401 and the lines connected thereto, the overall signal delay including the signal delay that occurs in the peripheral lines of the macro can be simulated.

However, it has now been discovered that since the related design method of Japanese Unexamined Patent Application Publication No. 11-259555 considers only the input terminal capacitance as the line delay component inside the macro, there is a large difference between the delay time of an actual LSI and the calculated value of the delay simulation and thereby the actual LSI does not operate in some cases. It is necessary to perform the circuit design again in such a case, which increases a design period. In order to prevent this error, it is necessary to place constraints to minimize the line length from the input terminal and output terminal of the macro to the first connected device in the layout process, which increases a design time.

One of the methods for solving the problem caused by the design method disclosed in Japanese Unexamined Patent Application Publication No. 11-259555 includes a design method disclosed in Japanese Unexamined Patent Application Publication No. 2006-301837. In Japanese Unexamined Patent Application Publication No. 2006-301837, the actual delay simulation is carried out in consideration of the line resistance and the line capacitance between the input terminal of the instance in a macro and a macro terminal, and the line resistance and the line capacitance between the output terminal of the instance in a macro and a macro terminal as the line delay component inside the macro. Accordingly, in the technique disclosed in Japanese Unexamined Patent Application Publication No. 2006-301837, the difference between the delay time of an actual LSI and the calculated value of the delay simulation is canceled.

### SUMMARY

However, the present inventors have found problems as follows even with the design method disclosed in Japanese Unexamined Patent Application Publication No. 2006-301837. Firstly, as this technique creates a line model in which only the line resistance and the line capacitance in a terminal line part in a macro are modeled and this line part is replaced with this line model for computerization, there is caused a difference between a simulation model and a line data on an actual LSI. More specifically, although the macro line is connected so that it extends in the same line layer as the line part between macros in the actual line data of LSI, it is treated as a line model which is divided into two on the input netlist of the delay simulation. Thus, there is caused a difference between the actual line data and the simulation model.

Secondly, when the influence of the target process on the line component varies or the accuracy of extraction of the line model increases, the line model at a time when the information of the target macro is created needs to be replaced with the latest line model in order to computerize the terminal line in a macro with the model of the line resistance and the line capacitance in advance. If this replacement is not performed, the difference between the delay simulation and the actual LSI becomes larger. In other words, if the line model is not updated, the accuracy of the delay simulation cannot be maintained. Furthermore, creating the information again for the purpose of avoiding this problem not only increases the number of steps but also decreases the reusability of the target macro.

A first exemplary aspect according to the embodiment of the present invention is a design method implementing automatic layout based on a first netlist created from a design circuit, including laying out a plurality of functional blocks of the design circuit based on the first netlist, creating a second netlist by adding a first path information to the first netlist, the first path information defining a path of an inter-block line connecting between the functional blocks, creating a third netlist by adding a second path information to the second netlist, the second path information defining a path of an intra-block line connected to a terminal of each functional block from inside of each functional block, creating an inter-instance line which combines the inter-block line and the intra-block line based on the first path information and the second path information included in the third netlist, and creating a fourth netlist that models a line resistance and a line capacitance of the inter-instance line, and estimating a delay time based on information of the fourth netlist.

A second exemplary aspect according to the embodiment of the present invention is a computer program product, in a computer readable medium, that causes a computer to execute estimation calculation of signal delay time in a design circuit, including instructions for: laying out functional blocks of the design circuit based on a first netlist, creating a second netlist by adding a first path information to the first netlist, the first path information defining a path of an inter-block line connecting between the functional blocks, creating a third netlist by adding a second path information to the second netlist, the second path information defining an intra-block line connected to a terminal of each functional block from inside of each functional block, creating an inter-instance line which combines the inter-block line and the intra-block line based on the first path information and the second path information included in the third netlist, and creating a fourth netlist that models a line resistance and a line capacitance of the inter-instance line, and causing the computer to execute the estimation calculation of the delay time based on information of the fourth netlist.

A third exemplary aspect according to the embodiment of the present invention is a netlist manipulation program that causes a computer to execute creation of a netlist used for calculation of signal delay time in a design circuit, the netlist manipulation program including a first memory that receives a second netlist describing information on a functional block of the design circuit created from layout arrangement based on a first netlist created from the design circuit and a first path information defining a path of an inter-block line connecting between the functional blocks, and storing a terminal name of the functional block, a second memory that stores a terminal name of a macro netlist in which a second path information is described, the second path information defining a path of an intra-block line connected to a terminal of the functional block from inside of the functional block, a comparator that compares the terminal name stored in the first memory with the terminal name stored in the second memory, and an adding portion that adds the second path information connected to a terminal corresponding to the matching terminal name in the macro netlist to the terminal of the second netlist whose terminal name is matched by the comparator.

According to the present invention, the third netlist is created by adding the information of the line connected to the terminal of the functional block from inside of the functional block to the line resistance and the line capacitance between the functional blocks of the design circuit. Then, the fourth netlist in which the line resistance and the line capacitance are modeled is created based on the line information of the third netlist. By performing the modeling of the line based on the fourth netlist thus created, the line between the functional blocks and the line in the functional block can be integrally modeled. This increases the estimation accuracy of signal delay time. The increase in accuracy of estimating the operation of an actual LSI in design phase brings the LSI in design phase nearer to perfection. Consequently, the present invention enables the reduction of redesign of the actual LSI and the shortening of the design time.

According to the present invention, the line resistance and the line capacitance are modeled by integrating the intra-macro line data and the inter-macro line data between macros for delay calculation, to thereby enable to decrease the difference between the delay time of the actual LSI and the delay time of the delay simulation, and to prevent the reversion to an earlier step in designing.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 shows a flow chart of a design method according to the present invention;

FIG. 2 shows one example of a schematic diagram of a layout diagram of a macro described in a netlist A0 according to the present invention;

FIG. 3 shows one example of a delay model with respect to the layout diagram shown in FIG. 2;

FIG. 4 shows one example of a schematic diagram of a layout diagram of a functional block according to the present invention;

FIG. 5 shows one example of a schematic diagram of an intra-block line of the functional block according to the present invention;

FIG. 6 shows one example of a schematic diagram of a layout diagram of the functional block according to the present invention;

FIG. 7 shows one example of a schematic diagram of a macro when the functional block is macro-modeled according to the present invention;

FIG. 8 shows one example of a delay model with respect to the layout diagram shown in FIG. 7;

FIG. 9 shows a flow chart of a method of creating a macro netlist according to the present invention;

FIG. 10 shows a flow chart of an operation procedure of a netlist manipulation program according to the present invention;

FIG. 11 shows one example of a schematic diagram of the layout diagram of the macro described in a netlist A1 according to the present invention;

FIG. 12 shows one example of a schematic diagram of the delay model of the macro described in a netlist A2 according to the present invention;

FIG. 13 shows a flow chart of a design method according to a related art; and

FIG. 14 shows a schematic diagram of a delay model created by the design method according to the related art.

### DETAILED DESCRIPTION OF THE EXEMPLARY EMBODIMENTS

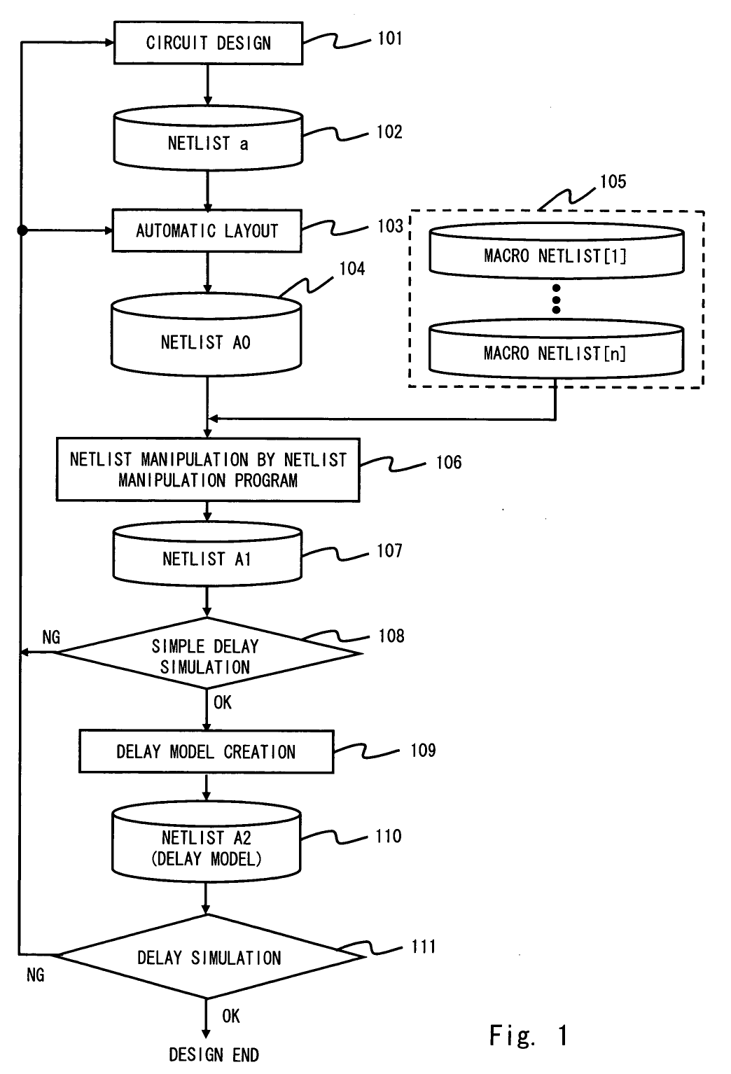

The exemplary embodiments of the present invention will now be described with reference to the drawings. FIG. 1 shows a flow chart of a design method according to the exemplary embodiment. The design method according to the exemplary embodiment will be described hereinafter with reference to FIG. 1.

The method first designs an overall LSI that has a plurality of functional blocks (a macro, an input/output buffer, and an input/output pad, for example) in the circuit design step (step 101). It then creates a first netlist (netlist a, for example) of the circuit designed in the circuit design step (step 102). According to the created netlist a, the method makes the layout diagram of the overall LSI in the automatic layout step by performing automatic arrangement and wiring of LSI (step 103).

After that, the method creates a second netlist (netlist A0, for example) that contains a first path information in which a path of inter-block line connecting between functional blocks is defined based on the layout diagram created in the automatic layout step (step 104). Then, the method adds information of a pre-prepared macro netlists [1] to [n] to the netlist A0 (step 105). This addition of the information is performed in the netlist manipulation process by the netlist manipulation program (step 106).

The netlist file in the macro includes a second path information in which a path of the intra-block line connected to the terminal of the functional block from inside of the functional block is defined. The netlist manipulation program adds the second path information of the macro netlist of the target functional block to the first path information including the functional block included in the netlist A0, so as to crate a netlist A1 which is a third netlist (step 107).

Subsequently, a simple simulation that calculates the signal delay time is carried out by a simple delay simulator, which is one of the functions included in the automatic layout device, using the netlist A1 (step 108). In this simple delay simulation, the delay simulation is carried out by applying the simple delay model of the line (with low accuracy), for example. When the specification of the LSI is not satisfied in this simple delay simulation (branch of NG), the process goes back to the automatic layout step (step 103) or the circuit design step (step 101). On the other hand, when the specification of the LSI is satisfied in the simple delay simulation (branch of OK), the step proceeds to the delay model creating process in step 109. It should be noted that the simple simulation of step 108 may be omitted.

In the delay model creating process, an inter-instance line which combines the inter-block line and the intra-block line connecting between the functional blocks is created from the netlist A1 created in step 107, and extracts a line resistance and a line capacitance of the inter-instance line. Then, the delay model including the information of the input terminal capacitance of the functional block and the extracted line resistance and the line capacitance are created, so as to create a fourth netlist (netlist A2, for example) including the delay model (step 110). Subsequently, the delay simulation is performed by the delay simulator using the netlist A2 to calculate the signal delay time (step 111). Note that the design is terminated when the delay time calculated in the delay simulation of step 111 is within the range of the specification (branch of OK), and on the other hand, the step goes back to the automatic layout step (step 103) or the circuit design step (step 101) when the delay time is outside the range of the specification to repeat this flow until when the delay time is within the range of the specification.

In the design method according to the exemplary embodiment, the design is carried out according to the above flow. Hereinafter, the operation in each step will be described in detail. In the following description, the layout data showing the functional block will be referred to as macro.

First, the netlist A0 which is created based on the layout created in the automatic layout step of step 103 will be described. FIG. 2 shows one example of the macro described in the netlist A0. As shown in FIG. 2, in the netlist A0, there are included a macro 201, instances INST1 to INST4, and a first circuit (inter-block lines R-NET1 to R-NET4, for example). The inter-block line R-NET1 connects the macro input terminal IN1 of the macro 201 with the instance INST1 of another macro. The inter-block line R-NET2 connects the macro input terminal IN2 of the macro 201 with the instance INST2 of another macro. The inter-block line R-NET3 connects the macro output terminal OUT1 of the macro 201 with the instance INST3 of another macro. The inter-block line R-NET4 connects the macro output terminal OUT2 of the macro 201 with the instance INST4 of another macro. In the netlist A0, the inter-block lines R-NET1 to R-NET4 are added to the netlist a.

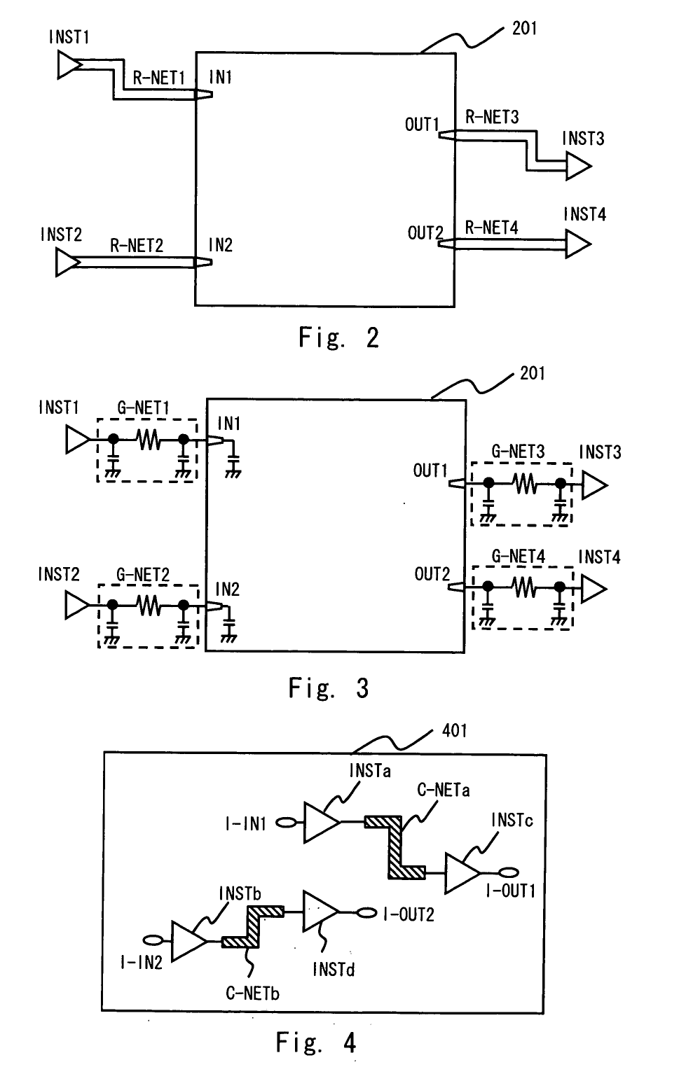

Although the delay model is not created in the netlist A0 in the design method according to the exemplary embodiment, a schematic diagram of a delay model corresponding to the layout diagram shown in FIG. 2 will be shown in FIG. 3 as a reference. As shown in FIG. 3, in the layout diagram shown in FIG. 2, there are included delay models G-NET1 to G-NET4 in which the line capacitance and the line resistance of the inter-block line are modeled as the delay model corresponding to the inter-block lines R-NET1 to R-NET4. Further, in the macro 201, the input terminal capacitance is added to the macro input terminals IN1 and IN2 including the input terminal attribute. The input terminal capacitance may be a sum of the line capacitance from the macro input terminal IN1 to the device which is in the first stage of the macro and connected to the macro input terminal IN1 and the gate capacitance of the device in the first stage of the macro.

Next, the macro netlist will be described. One example of the schematic diagram of the internal circuit of a functional block 401 employed in the exemplary embodiment will be shown in FIG. 4. As shown in FIG. 4, the functional block 401 includes instances INSTa to INSTd as a circuit element. The instances INSTa and INSTb are input buffers, for example. Further, the instances INSTc and INSTd are output buffers, for example. The instance INSTa and the instance INSTc are connected by an intra-cell line C-NETa. Further, the instance INSTb and the instance INSTd are connected by an intra-cell line C-NETb.

The functional block 401 may be the one in which the instances and the intra-cell lines are registered as a library beforehand. Otherwise, the instances and the intra-cell lines may be created by the automatic layout step in step 103. However, in order to simplify the automatic layout for the functional block 401, a boundary of the block is set in a region surrounding the periphery of the block in the functional block 401. The terminal of the functional block 401 is set along with the boundary. Note that, in FIG. 4, the input terminals of the instances are denoted by I-IN1 and I-IN2 and the output terminals of the instances are denoted by I-OUT1 and I-OUT2 in order to make a distinction between the block terminal arranged along with the block boundary, and the input terminal or the output terminal of the instance.

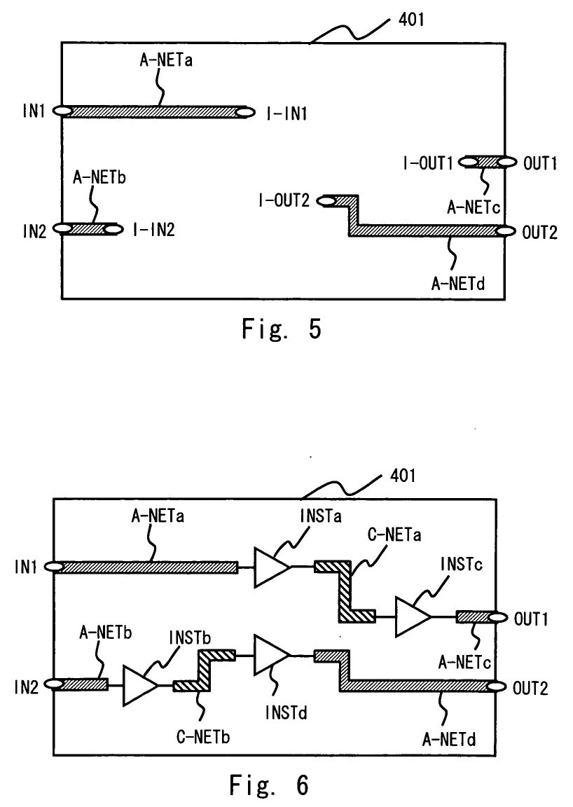

FIG. 5 shows a schematic diagram of the intra-block line arranged corresponding to the layout of the functional block of FIG. 4. As shown in FIG. 5, the functional block 401 includes intra-block lines A-NETa to A-NETd. The intra-block line A-NETa connects the macro input terminal IN1 with the input terminal of the instance I-IN1. The intra-block line A-NETb connects the macro input terminal IN2 with the input terminal of the instance I-IN2. The intra-block line A-NETc connects the macro output terminal OUT1 with the output terminal of the instance I-OUT1. The intra-block line A-NETd connects the macro output terminal OUT2 with the output terminal of the instance I-OUT2.

In the actual layout diagram, the diagram of the functional block includes the internal circuit of the functional block 401 shown in FIG. 4 and the intra-block line of the functional block 401 shown in FIG. 5. Now, the layout diagram of the functional block 401 in the actual layout diagram will be shown in FIG. 6.

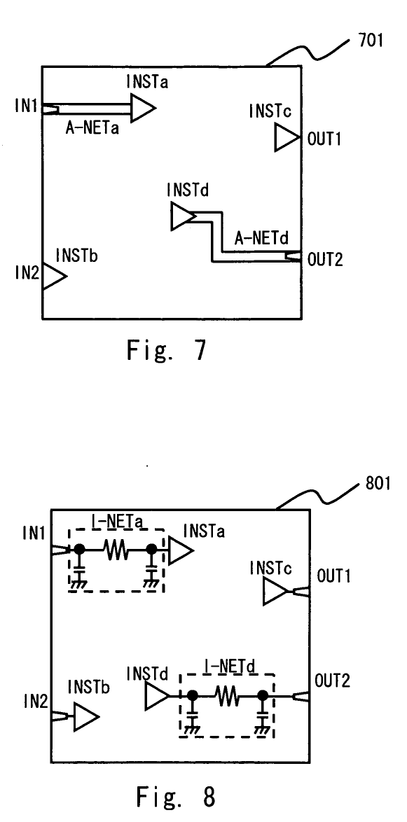

In the exemplary embodiment, the instances INSTa to INSTd, a second circuit (intra-block lines A-NETa to A-NETd), the macro input terminals IN1 and IN2, and the macro output terminals OUT1 and OUT2 are included as the macro netlist. In the exemplary embodiment, the intra-block lines A-NETb and A-NETc of the second circuit are made short so that the line resistance and the line capacitance can be ignored, and the information regarding the intra-block lines A-NETb and A-NETc is omitted from the macro netlist. FIG. 7 shows a schematic diagram of a macro 701 obtained from the information included in the macro netlist. Further, in the design method in the exemplary embodiment, the delay model which only includes the intra-block line is not created, but the delay model of the intra-block line included in the macro 701 is shown in FIG. 8 as a reference. As shown in FIG. 8, the macro 701 includes delay models I-NETa and I-NETd that model the line resistance and the line capacitance of the intra-block line included in the macro netlist.

This macro netlist needs not be created by calculation or the like as it may be registered as the library when the graphics of the functional block is predefined. On the other hand, when the graphics of the functional block is created by the automatic layout step in step 103, the macro netlist needs to be created by the calculation or the like. The procedure for creating the macro netlist will hereinafter be described.

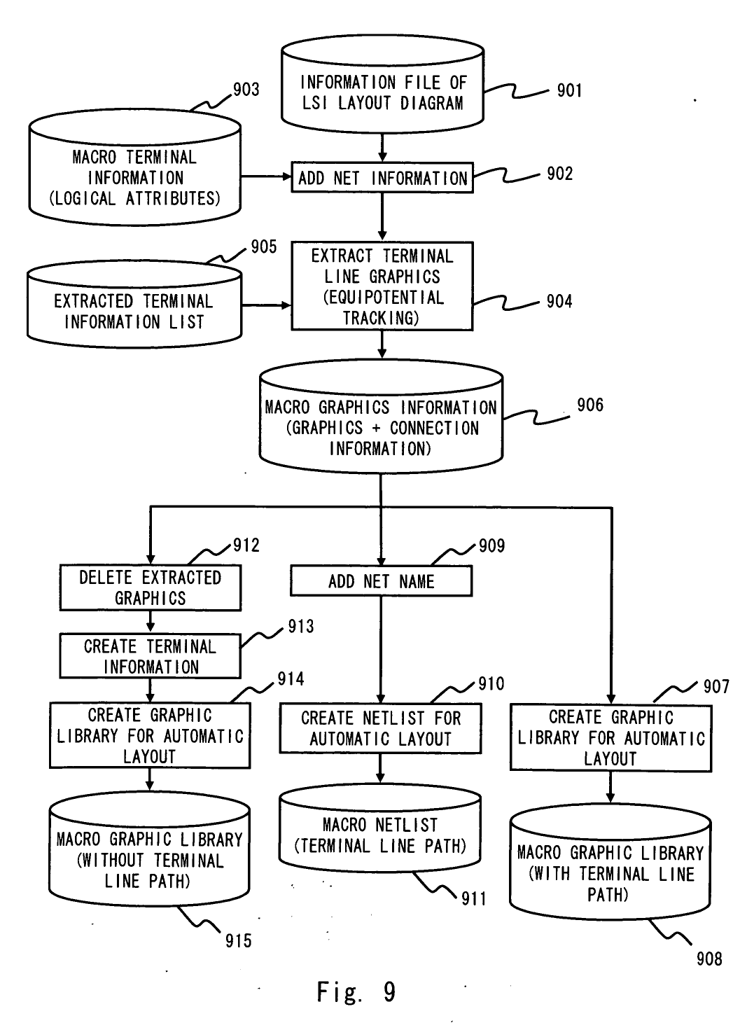

FIG. 9 shows a flow chart showing a procedure to create the macro netlist. Note that the procedure shown in FIG. 9 is realized by executing the program by a computing unit such as a computer.

As shown in FIG. 9, the information file of the layout diagram of the LSI created in the automatic layout step in step 103 is read out (step 901). Then, the information of the net (line) is extracted from the information file of the graphics that is read out, and adds the information to each net (step 902). In adding the information in step 902, the terminal information of the macro that is preset is read out (step 903). The logical attributes for each terminal to which the net is connected are described in the terminal information of this macro. The logical attributes include the information indicating whether the terminal corresponds to the input terminal or to the output terminal, and the frequency information of the signal input and output through the terminal, for example.

Subsequently, the terminal line graphics of the terminal to which the net information is added is extracted (step 904). In the processing of step 904, the list information of the macro input terminal and the macro output terminal of the functional block (extracted terminal information list, for example) is read out (step 905), and the graphics is searched by equipotential tracking between terminals described in this extracted terminal information list. Then, the graphic information identifying the position of the terminal or the like included in the extracted terminal information list is extracted. The graphic information in the macro is created based on the information extracted in step 904 (step 906). This graphic information in the macro includes the graphics of the line and the instance in the macro, and the connection information thereof, for example. One example of the schematic diagram obtained by visualizing the graphic information in the macro is the schematic diagram of the functional block shown in FIG. 6.

Subsequently, in creating the macro netlist, the net names of the macro input terminal and the macro output terminal and the intra-block line included in the macro netlist are added (step 909). In the example of FIG. 6, the net names are added to the intra-block lines A-NETa, A-NETd, the macro input terminals IN1, IN2, and the macro output terminals OUT1, OUT2. Then, the processing for creating the netlist for automatic layout is carried out (step 910) to create the macro netlist (step 911).

Further, the macro graphic library may be created separately from the macro netlist. For example, two kinds of macro graphic libraries are possible. One macro graphic library is the detailed macro graphic library including the terminal line path including the intra-block line (library created in step 908). The other macro graphic library is the one in which the line graphics in the macro is omitted and the information of each of the macro input terminal and the macro output terminal is moved to the position of the input terminal and the output terminal of the instance in the macro, respectively (library created in step 915).

When the former macro graphic library is created, the graphic library for the automatic layout is created based on the graphic information in the macro created in step 906 (step 907). Then, the macro graphic library is created by the processing of step 907 (step 908). This macro graphic library includes the information of the functional block shown in FIG. 6, for example.

When the latter macro graphic library is created, the graphic information regarding the instance and the line is deleted from the graphic information in the macro created in step 906 (step 912). Subsequently, the terminal information is created in which each of the macro input terminals IN1 and IN2 is moved to the position of the input terminals I-IN1 and I-IN2 and each of the macro output terminals OUT1 and OUT2 is moved to the position of the output terminals I-OUT1 and I-OUT2 (step 913). Then, the graphic library for the automatic layout is created based on the information created by the processing in step 913 (step 914). By the processing in step 914, the macro graphic library is created (step 915). This macro graphic library includes the information corresponding to the macro 401 shown in FIG. 4, for example.

In the exemplary embodiment, the netlist A1 is newly created using the list A0 and the macro netlist created in step 911. The processing for creating the netlist A1 is performed in the netlist manipulation process in step 106 shown in FIG. 1. Hereinafter, the netlist manipulation process will be described in detail.

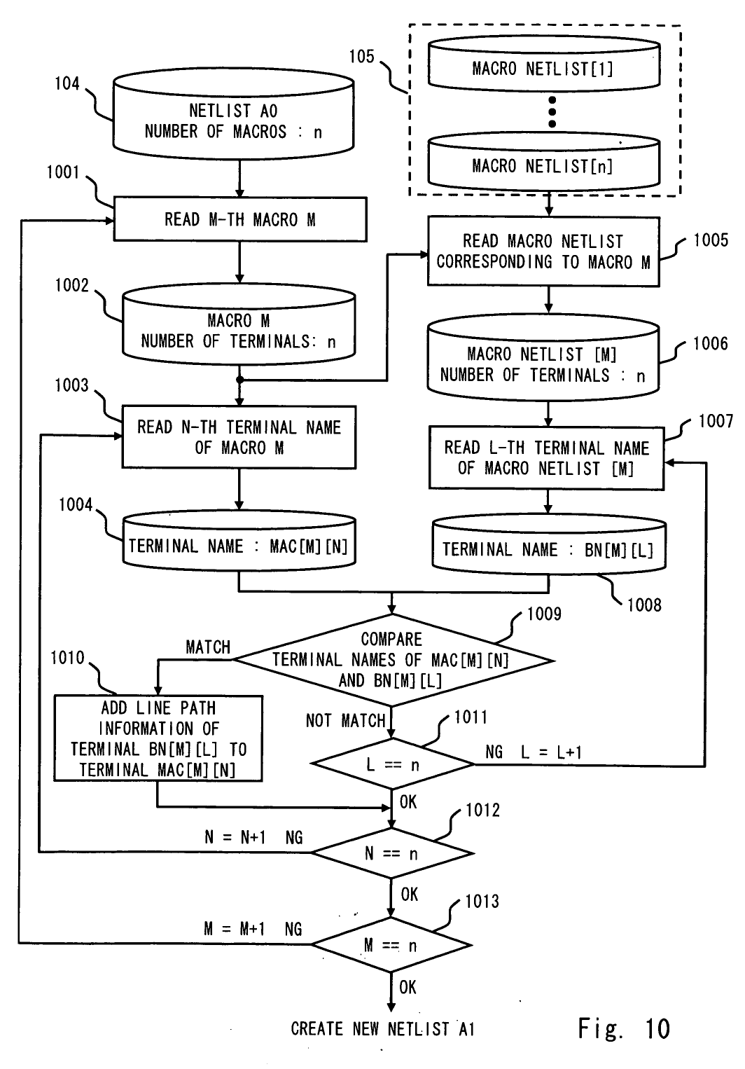

In the netlist manipulation process, the netlist A1 is newly created by adding the netlist A0 and the macro netlist by the netlist manipulation program. FIG. 10 shows a flow chart in which the netlist manipulation program creates the netlist A1. In the example shown in FIG. 10, the netlist A0 includes n macros. Further, n macro netlists are prepared according to the number of macros in the netlist A0. Furthermore, each of the n macros includes n terminals.

The netlist manipulation program first reads the M-th macro M in the netlist A0 (step 1001). For example, if the initial value of M is 1, it reads the macro 1, which is the first macro. The program then stores the read macro M into memory (step 1002).

Then, the netlist manipulation program reads the N-th terminal name of the macro M (step 1003). If the initial value of N is 1, for example, it reads the terminal name of the first terminal of the macro 1. The program then stores the read terminal name into MAC[1][1] of memory MAC[M][N] (step 1004).

Further, the program reads the macro netlist which corresponds to the macro M (step 1005). For example, it reads the macro netlist [1] which corresponds to the macro 1. The program then stores the read macro netlist [1] into memory (step 1006). Then, it reads the L-th terminal name in the macro netlist [1] (step 1007). If the initial value of L is 1, for example, it reads the terminal name of the first terminal. The program then stores the read terminal name into BN[1][1] of memory BN[M][L] (step 1008).

After that, the program compares the terminal name of the macro M which has been stored in the memory MAC[M][N] in step 1004 with the terminal name in the macro netlist [M] which has been stored in the memory BN[M][L] in step 1008 (step 1009). If the comparison result shows that the stored terminal names match with each other, the program inserts the intra-block line A-NET which is connected to the L-th terminal in the macro netlist [M] between the N-th terminal of the macro M and the inter-block line R-NET connected to the terminal in the netlist A0 (step 1010).

If, on the other hand, the comparison result in step 1009 shows that the terminal names do not match, the program adds one to the terminal number L in the macro netlist [M] and repeats this process until the terminal number L reaches the number of terminals n (step 1011). For example, if the first terminal name BN[1][1] in the macro netlist [1] and the terminal name MAC[1][1] do not match, the program returns to step 1007 and reads the second terminal name BN[1][2]. This process is repeated until the terminal names match or the terminal number L becomes the same as the number of the terminals n. The program searches the first terminal to the n-th terminal of the macro netlist [M] and, if the terminal names do not match, proceeds to the next step.

When step 1010 or step 1011 completes, the program adds one to the terminal number N of the macro M. This process is repeated until the terminal number N equals the number of terminals n of the macro M (step 1012). For example, if the process of step 1010 or step 1011 completes on the first terminal of the macro 1, the program returns to step 1003 and reads the second terminal name of the macro 1. After that, the program again repeats the process from step 1007 to step 1011. If the process from step 1007 to step 1011 completes, the program again returns to step 1003 and reads the next terminal name of the macro M. This process is repeated until the reading completes on all the terminals of the macro M. The process proceeds to the next step when the terminal number N of the macro M becomes the same as the number of terminals n.

When step 1012 completes, the process adds one to the next macro number M of the netlist A0. This process is repeated until the macro number M equals the number of the macros n (step 1013). For example, if the process of step 1001 to step 1012 completes on the macro 1, which is the first macro, the program returns to step 1001 and reads the macro 2, which is the second macro. After that, the program performs step 1002 to step 1012. This process is performed on all the macros and, when the macro number M becomes the same as the number of macros n, terminates the process.

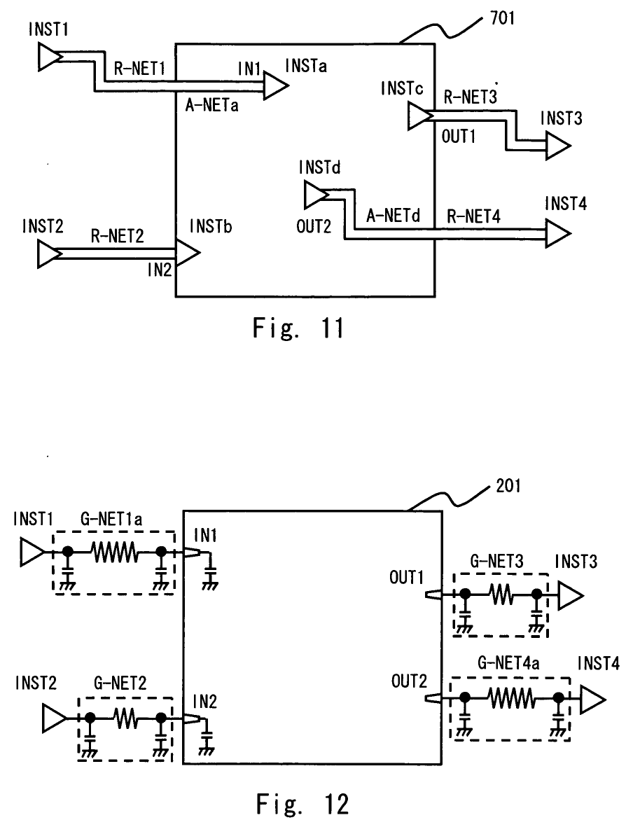

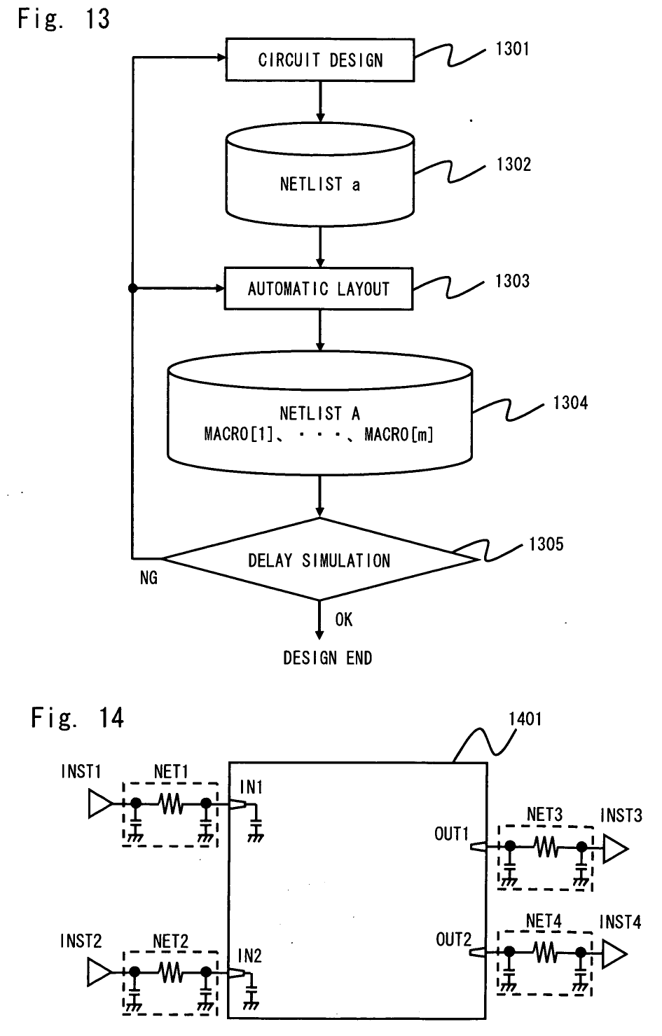

As a result of steps 1001 to 1013, information on A-NET is added to all the terminals of all the macros, and a new netlist A1 is thereby created. FIG. 11 shows a schematic diagram of the macro described in the netlist A1 and a layout diagram of the lines connected to the macro. As shown in FIG. 11, the layout diagram of the netlist A1 includes a third circuit (inter-instance line, for example) in which the inter-block line R-NET described in the netlist A0 and the intra-block line A-NET described in the macro netlist are combined. In the delay model creating process of step 109 in the exemplary embodiment, the delay model is created using the inter-instance line in the netlist A1. Note that the inter-instance line means the line formed by combining the inter-block line R-NET and the intra-block line.

Referring now to FIG. 12, a schematic diagram of a delay model created in the delay model creating process in step 109 will be described. As shown in FIG. 12, there are included delay models G-NET1a, G-NET2, G-NET3, and G-NET4a in the exemplary embodiment. These delay models are arranged between each of the terminals of the macro 201 and each of the instances corresponding to the terminals.

To be more specific, the delay model G-NET1a is connected between the macro input terminal IN1 and the instance INST1. The delay model G-NET2 is connected between the macro input terminal IN2 and the instance INST2. The delay model G-NET3 is connected between the macro output terminal OUT1 and the instance INST3. The delay model G-NET4a is connected between the macro output terminal OUT2 and the instance INST4.

At this time, there is no intra-block line described in the macro netlist for the macro input terminal IN2 and the macro output terminal OUT1 in the exemplary embodiment. Therefore, the delay model is the same as that shown in FIG. 3 for the macro input terminal IN2 and the macro output terminal OUT1. On the other hand, there is an intra-block line described in the macro netlist for the macro input terminal IN1 and the macro output terminal OUT2. Thus, the delay models G-NET1a and G-NET4a include a combined resistance of the line resistance of the intra-block line A-NET and the line resistance of the inter-block line R-NET, and a combined capacitance of the line capacitance of the intra-block line A-NET and the line capacitance of the inter-block line R-NET. In other words, in the exemplary embodiment, the inter-instance line is created as a line combining the inter-block line R-NET and the intra-block line A-NET, and the delay model for this inter-instance line (delay models G-NET1a and G-NET4a, for example) is created. Then, the delay simulation is carried out with the netlist A2 including the thus-created delay model.

As will be understood from the above description, according to the design method of the exemplary embodiment, the line resistance and the line capacitance of the inter-block line R-NET connecting between the functional blocks of the design circuit and the line resistance and the line capacitance of the intra-block line A-NET in the functional block are combined as the extending amount of the line resistance and the line capacitance of the inter-block line R-NET of the design circuit. As such, the delay model can be accurately reproduced according to the actual layout diagram. Thus, with the accurate reproduction of the delay model according to the actual layout diagram, the signal delay time that occurs in the line from the terminal of the functional block to the internal device of the functional block can be estimated with high accuracy. More specifically, the processing which is similar to the actual layout diagram pattern is implemented, to thereby enable to increase the estimation accuracy of the signal delay time. Further, highly accurate delay simulation increases the estimation accuracy of the operation of the actual LSI in the design phase and brings the LSI in design phase nearer to perfection. Consequently, the present invention enables the reduction of redesign of the actual LSI and the shortening of the design time.

Furthermore, the design method of the exemplary embodiment uses the information in a state of the wiring path information, which is a state previous to the changing of the information of the line connected to the terminal of the functional block from inside of the functional block to the model information of the line resistance and the line capacitance. As such, the difference between the actual layout diagram and the delay model can be minimized in modeling the line between the functional blocks of the layout diagram including a long line connected from the external terminal of the functional block to inside of the functional block in the functional block. This also enables to increase the accuracy of the delay simulation.

Furthermore, in the design method according to the exemplary embodiment of the present invention, instead of presetting the delay model as the macro model of the functional block, the delay model is created for the line in which the intra-block line A-NET is connected to another line in a later process. By creating the delay model each time, the change of the method of creating the delay model or the effect due to the increase of the accuracy of the element model included in the delay model can be reflected each time. As such, the modeling condition of the intra-block line A-NET of the functional block can be equalized with the inter-functional block line in overall simulation of LSI. Further, even when the functional block and the chip are designed at different times, the accuracy of the line modeling can be equalized with respect to the line between the functional blocks and the line in the functional block.

Note that the present invention is not limited to the above described exemplary embodiment, but may be changed as appropriate without departing from the spirit of the present invention. For example, the method of creating the macro netlist in FIG. 10 can be changed as appropriate according to the specification of the layout tool or the circuit design tool. Further, the macro netlist may be created only for the line whose length of the intra-block line is 10 um or more, for example, in a step of creating the macro netlist when it is predetermined that the effect of the delay is significant with the line length of 10 um or more. In summary, the path information included in the macro netlist can be determined as appropriate according to the accuracy of the delay calculation and the product specification.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A design method implementing automatic layout based on a first netlist created from a design circuit, comprising:
laying out a plurality of functional blocks of the design circuit based on the first netlist;
creating a second netlist by adding a first path information to the first netlist, the first path information defining a path of an inter-block line connecting between the functional blocks;
creating a third netlist by adding a second path information to the second netlist, the second path information defining a path of an intra-block line connected to a terminal of each functional block from inside of each functional block;
creating an inter-instance line which combines the inter-block line and the intra-block line based on the first path information and the second path information included in the third netlist, and creating a fourth netlist that models a line resistance and a line capacitance of the inter-instance line; and
estimating a delay time based on information of the fourth netlist.

2. The design method according to claim 1, wherein the fourth netlist includes a combined resistance and a combined capacitance calculated from a line resistance and a line capacitance of the inter-block line and a line resistance and a line capacitance of the intra-block line as the line resistance and the line capacitance of the inter-instance line.

3. The design method according to claim 1, wherein the second netlist includes the first path information as a first circuit.

4. The design method according to claim 1, wherein the addition of the second path information to the second netlist prepares a macro netlist for each of the functional blocks and adds information on the macro netlist corresponding to the terminal of the functional block to be described in the second netlist.

5. The design method according to claim 4, wherein the macro netlist corresponds to the functional block described in the second netlist, and describes a netlist of the intra-block line connected to a terminal corresponding to the terminal of the functional block.

6. The design method according to claim 4, wherein the macro netlist includes a second circuit modeling a line from a terminal of the functional block to an internal device first-connected in the functional block.

7. The design method according to claim 1, wherein the third netlist includes a third circuit where a second circuit corresponding to the second path information is inserted between a first circuit corresponding to the first path information and the terminal of the functional block.

8. A computer program product, in a computer readable medium, that causes a computer to execute estimation calculation of signal delay time in a design circuit, comprising instructions for:
laying out functional blocks of the design circuit based on a first netlist;
creating a second netlist by adding a first path information to the first netlist, the first path information defining a path of an inter-block line connecting between the functional blocks;
creating a third netlist by adding a second path information to the second netlist, the second path information defining an intra-block line connected to a terminal of each functional block from inside of each functional block;
creating an inter-instance line which combines the inter-block line and the intra-block line based on the first path information and the second path information included in the third netlist, and creating a fourth netlist that models a line resistance and a line capacitance of the inter-instance line; and
causing the computer to execute the estimation calculation of the delay time based on information of the fourth netlist.

9. A netlist manipulation program that causes a computer to execute creation of a netlist used for calculation of signal delay time in a design circuit, the netlist manipulation program comprising:
a first memory that receives a second netlist describing information on a functional block of the design circuit created from layout arrangement based on a first netlist created from the design circuit and a first path information defining a path of an inter-block line connecting between the functional blocks, and storing a terminal name of the functional block;
a second memory that stores a terminal name of a macro netlist in which a second path information is described, the second path information defining a path of an intra-block line connected to a terminal of the functional block from inside of the functional block;
a comparator that compares the terminal name stored in the first memory with the terminal name stored in the second memory; and
an adding portion that adds the second path information connected to a terminal corresponding to the matching terminal name in the macro netlist to the terminal of the second netlist whose terminal name is matched by the comparator.

10. The netlist manipulation program according to claim 9, wherein the macro netlist is a file prepared in a circuit design phase.
